(19) United States
(12) Patent Application Publication
(10) Pub. No.: US 2013/0068803 A1
(43) Pub. Date: Mar. 21, 2013

(54) Skate Boot Clamp To Aid In The Tying Of Laces Tightly On Ice And Roller Skates

(71) Applicant: Marc Leo Brodeur, Novato, CA (US)

(72) Inventor: Marc Leo Brodeur, Novato, CA (US)

(21) Appl. No.: 13/601,600

(22) Filed: Aug. 31, 2012

Related U.S. Application Data
(60) Provisional application No. 61/530,825, filed on Sep. 2, 2011.

(51) Int. Cl. A47G 25/80; B25B 27/14

(52) U.S. Cl. 223/113; 29/281.5; 29/270

(57) ABSTRACT

This clamp facilitates the firm tying of ice and roller skates by clamping the two sides of the skate boot and holding them. This makes it easy for children and adults to produce a more uniform tightness while reducing hand fatigue and string-burn. By reducing the friction normally caused by the yanking of strings through the eyelets, string life will be prolonged. An alternate use of this clamp is to facilitate the firm tying of other clothing items with laces. Another alternative use of this clamp is to facilitate the firm tying of other non-clothing items with laces.

The present application is a nonprovisional of U.S. Provisional Patent Application Ser. No. 61/530,825, filed Sep. 2, 2011. The present application is based on and claims priority from this application, the disclosure of which are hereby expressly incorporated herein by reference.

### BACKGROUND OF THE INVENTION

There are many different types of footware available, many of which have laces used to tighten the footware. For certain types of footware it is important that the laces be tightened firmly, for example ice and roller skates.

The lacing of ice and roller skates can present a problem for some skaters due to the necessity to tightly tie the laces. Certain skaters do not have sufficient strength or agility to tie skate laces sufficiently tight. One specific group of skaters where this can be a problem is where the skaters are children.

An additional problem resulting from the tying of laces tightly is the friction between the eyelets of skates and the laces, causing wear on laces over time.

### BRIEF SUMMARY OF THE INVENTION

The present invention is directed to a clamp that facilitates the firm tying of footware by clamping the two sides of the footware and holding them in place for the laces to be tied. This makes it easy for children and adults to produce a more uniform tightness while reducing hand fatigue and string-burn.

In addition, by reducing the friction normally caused by the yanking of strings through the eyelets, lace life will be prolonged.

### BRIEF DESCRIPTION OF THE SEVERAL VIEWS OF THE DRAWINGS

The drawings furnished herewith illustrate a preferred construction of the present invention in which the advantages and features described are clearly disclosed as well as others which will be readily understood from the following description of the illustrated embodiment.

In the drawings:

FIG. 1 is a Front Isometric View of the clamp.

FIG. 2 is a Rear Isometric View of the clamp.

FIG. 3 is a Top Plan View of the clamp in use.

FIG. 4 is a Section View of the clamp in use, showing alternate positions.

FIG. 5 is an Exploded View of the clamp showing all components numbered.

### LIST OF COMPONENT NUMERALS IDENTIFIED IN THE DRAWINGS

1—Rail
2—Clamp Jaw
3—Clamp Tooth
4—Jaw-Rail Bolt
5—Jaw-Rail Lock Knob
6—Threaded Rod
7—Tubing
8—Clamp Adjust Knob
9—Compression Spring
10—Spring Keeper Nut and Washer
11—Stop Nut
12—Width Adjustment Nut
13—T-Nut
14—Clamp
15—Ice Skate (in use)

### DETAILED DESCRIPTION OF THE INVENTION

The present invention is directed to a clamp of use in the aid of tying laces on footware, and in particular in the clamping of footware where tightness is crucial. A specific embodiment of the invention is for aid of tightening laces on ice and roller skates. The invention is used to clamp the two sides of the footware to the desired tightness, allowing the user to easily tie the laces of the footware such that the laces are tied to the desired tightness of the footware. The invention is chiefly concerned with the tightening of footware, but the principles of the invention are applicable to other items.

There are several devices and prior patents that currently exist that assist in the tying of laces for skates and other footware, which fall into two categories. The first generally consists of a hook type device that assists in the pulling of laces as they are being tied, in order to increase the tension applied to the laces. The second generally applies to differing devices for the securing of laces once they have been tightened. In none of these devices or prior patents is a clamp used to holding skates closed in order to assist in the tying of skate laces.

### DETAILED DESCRIPTION OF FIRST PREFERRED EMBODIMENT

A present invention is directed to a clamp designed to fit any size of footware, for the purpose of holding the footware to a desired tightness in order to allow for the easy tying of laces such that the footware is tied uniformly and to the desired tightness.

In one preferred embodiment of the present invention, the footware is an ice or roller skate, where tightness is essential and may be difficult to achieve for certain users.

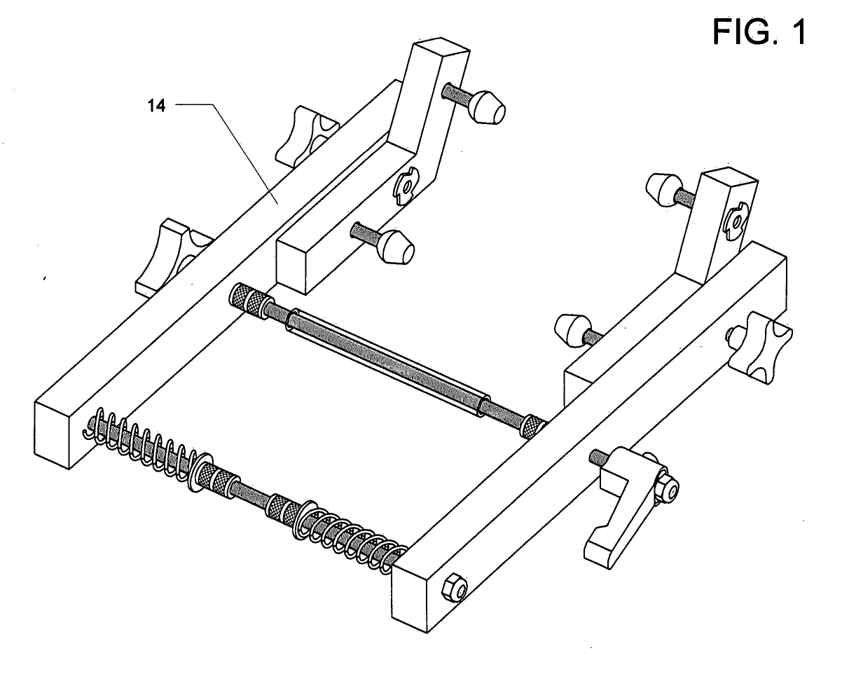

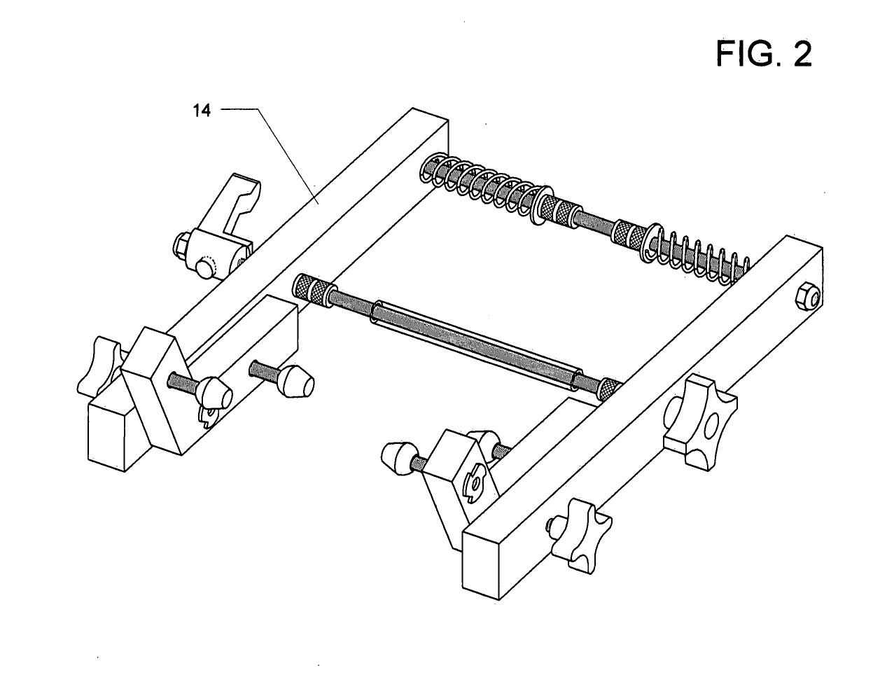

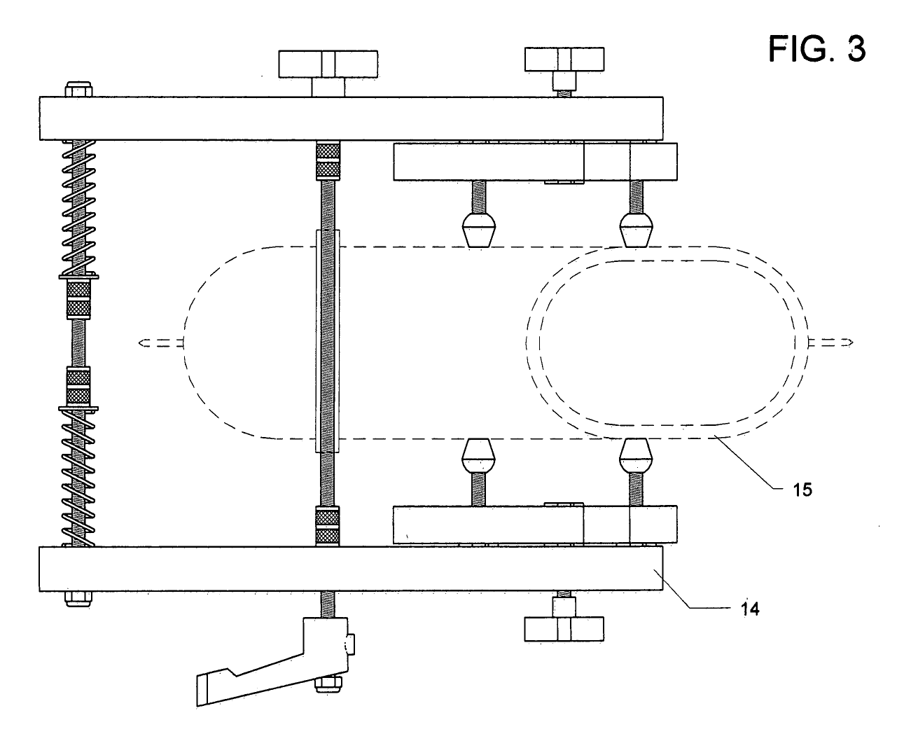

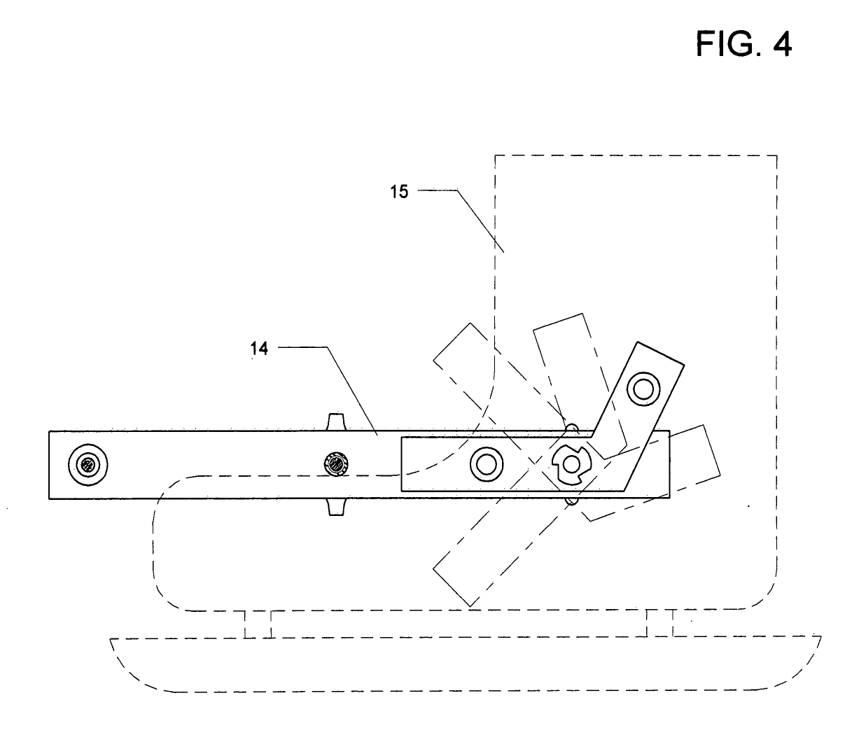

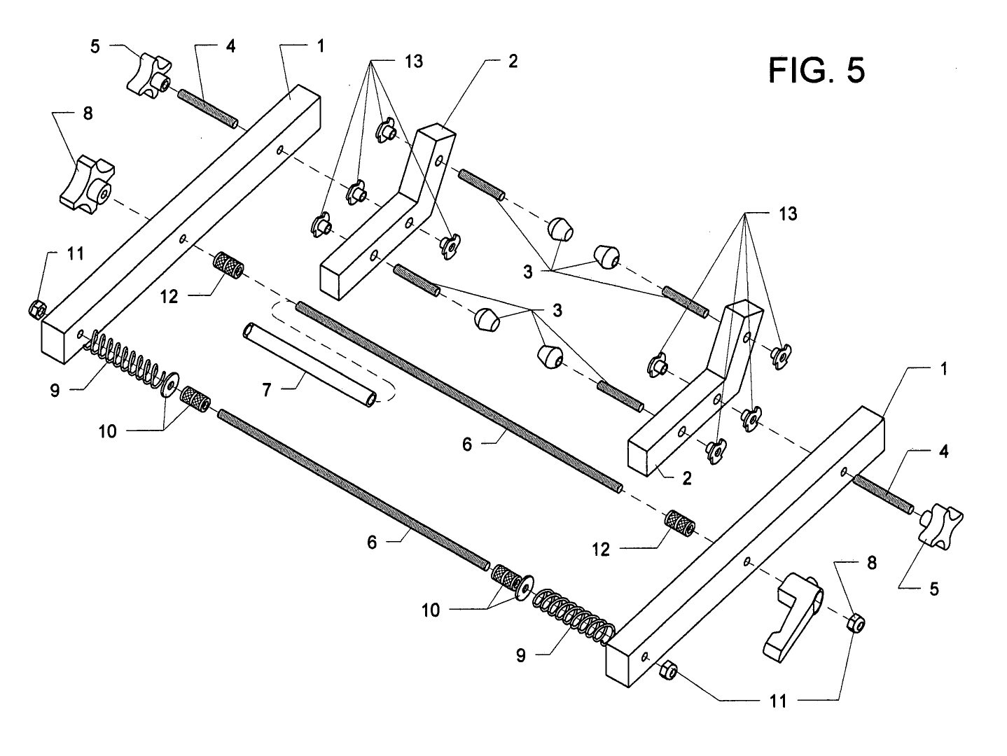

FIGS. 1 and 2 show a first preferred embodiment of the present invention from varying angles. FIGS. 3 and 4 shows this preferred embodiment of the present invention from varying angles as it will be used. FIG. 5 shows an exploded view of the components of this preferred embodiment of the present invention.

In this preferred embodiment, the skate clamp 14 consists of two Rails 1 with three holes in each. The Rails 1 held apart by two Rods 6 through first and second holes of Rails 1.

The first Rod 6 through the first holes of Rails 1 is held in place by Stop Nuts 11 at the outside of each Rail 1. On first Rod 6, a Compression Spring 9 is place against the inside face of each Rail 1. Compression Springs 9 are held against Rails 1 by means of Spring Keeper Nuts and Washers 10.

The second Rod 6 through the second holes of Rails 1 controlls the distance apart of Rails 1 with Width Adjustment Nuts 12 at insides of Rails 1 and Clamp Adjust Knobs 8 to the outsides of Rails 1 attached to second Rod 6. A Tube 7 is sleeved over second Rod 6.

The third holes of Rails 1 accommodate the Jaw-Rail Bolt 4. Jaw-Rail Bolt 4 holds Clamp Jaws 2 to Rails 1 by way of Jaw-Rail Lock Knobs 5 using a hole in Clamp Jaws 2. This preferred embodiment calls for a T-Nut 13 and a Male Jaw-Rail Lock Knob 5, but an alternative embodiment consists of a carriage bolt and female knob. Two Clamp Teeth 3 are attached to each Clamp Jaw 2. The Jaw-Rail Bolt 4 allows for rotation of Clamp Jaws 2 to accommodate different shapes and sizes of footwear.

### Example Component Materials and Construction of the First Preferred Embodiment of the Present Invention:

The Rails 1 are hardwood, and are ¾″ thick×1″ wide×12″ long. In addition, the Rails 1 are have edges that are beveled for comfort. The Rails are are drilled with holes center-line of width, first hole at 1¾ ″ from first end, second hole at 5½″ from first end, and third hole at 2″ from other end. The Rods 6 are 10″ long and are ¼-20 threaded. The Tube 7 is 5/16″ ID vinyl. The Compression Spring 9 is 9/16×3″.

The Clamp Jaws 2 form a 120 degree “dogleg”. Each Clamp Jaw 2 has two legs. The vertical leg measures 2¾″ to the long point and 4¼″ to the long point on the horizontal leg. The opposite ends of each leg are square. The Clamp Jaws 2 are made from ¾ “hardwood plywood×1” wide and are made in one piece—no joints. The Clamp Teeth 3 can be rubber tipped, and are attached to Clamp Jaws 2 by way of t-nut or nut and bolt, center-line of width, 1¾″ from square end of horizontal leg, and ¾″ from square end of vertical leg. Hole in each Clamp Jaw 2 to accommodate Jaw-Rail Bolt 4 are drilled, center-line of width, 3¼″ from square end of horizontal leg.

Proposed Operation of this Preferred Embodiment of the Present Invention:

To use the Clamp 14 user must first put footware onto his/her feet. While seated, user will orient Clamp 14 with Clamp Jaws 2 toward user. While holding Jaws 2 open (either by pulling apart Rails 1 at Jaw 2 end or by pushing Rails 1 together at Spring 9 end) slide Jaws 2 of Clamp 14 over footware so that upper-most Rubber Clamp Teeth 3 are located just behind the top eyelets of footware.

While keeping Top Tooth 3 situated rotate Jaws 2 so lower Teeth 3 are behind lace eyelets of footware. Be sure to keep Rubber Clamp Teeth 3 away from laces to ensure a more even tightness and eliminate pre-mature wear to laces.

After Jaws 2 are properly located (see FIGS. 3 and 4), tighten Clamp Adjust Knob 8 to a comfortable tightness. Pull laces tight to tongue of footware but no tighter. The Clamp 14 has pulled user's footware tight for him/her. Tie footware as usual.

Footware tightness can be adjusted by way of the Width Adjustment Nut 12. After footware is tied, loosen Clamp Adjust Knob 8, spread Jaws 2 as before, remove Clamp 14 and install onto footware on other foot.

Alternative Components and Materials of this Preferred Embodiment of the Present Invention.

Many alternative components and materials may be used in this preferred embodiment of the present invention.

As an alternative to wood, the Rails 1 and Jaws 2 could be made of any number of metals or even plastics having sufficient strength to overcome bending.

T-nuts can be used for connecting Clamp Jaws 2 to Rails 1. Compression Springs 9 come in many sizes and one may be substituted.

Rods 6 may be plastic threaded if strong enough.

All knobs (Jaw-Rail Lock Knob 5 and Clamp Adjust Knob 8) can alternatively be levers.

An additional stop nut may be placed on Threaded Rod 6 on the inside of each Rail 1, acting as an adjustable stop to the tightening of each Clamp Adjust Knob 8, in order to facilitate repetitive consistent tightening.

The Clamp Teeth 3 may alternatively be plain steel or plastic carriage bolts.

The Tubing 7 is intended to protect the footwear, and can be cut to any desired length to accommodate travel on Threaded Rod 6 by Rail 1.

### Alternative Embodiments

There are many alternative embodiments of the present invention.

This invention has been designed with hockey skates in mind but it can be used with figure skates and any other footware where tightness is crucial. In addition, it may also be used for other forms of clothing or other non-clothing items entirely, where some form of laces or other attachment is used.

Certain components of the device in the preferred embodiment detailed above are directly related to the shape of the skate being tightened. For example, the Rail 1 and the Clamp Jaw 2 are shaped to closely match the laces as they curve up the skate, allowing the preferred embodiment to clamp the skate close to the line of the laces. As a result, other embodiments of the present invention applied to items of differing shapes will likely have differing components, shapes and sizes in order to fit the appropriate item and the laces being tied.

Another embodiment of the present invention allows the clamp to be attached to the item being tightened using a variety of attachment methods, rather than clamping each side of the item and/or using friction to securely hold the item.

### Miscellaneous

For the purpose of consistency, in this application every attempt was made to use terminology consistently. It should be noted, however, that alternative embodiments are possible and are not excluded from the scope of the invention.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A clamping device to assist in the tying of laces on an item, said item being any item using laces, comprising:
two clamp jaws, each said clamp jaw consisting of at least one component;
one tightening mechanism attached to each clamp jaw, said tightening mechanism consisting of at least one component;
wherein said clamping device may be placed over said item, such that said two clamp jaws are positioned on each side of said item;
wherein said tightening mechanism can be tightened such that said item is securely held by said clamping device to desired tightness;
wherein said laces can be tied on said item;
wherein said tightening mechanism can be un-tightened such that said clamping device can be removed from said item; and
wherein said tied laces maintain said desired tightness of said item.

2. The clamping device of claim 1 wherein said item can be at least one of the following:
an ice skate with laces;
a roller skate with laces;
some other item of footware with laces;
some other item of clothing with laces; and
some other item with laces.

3. The clamping device of claim 1 wherein said tightening mechanism can be operated in at least one of the following methods:
manually by twisting a knob;
manually by adjusting a lever;
manually by some other method;
with the use of a pneumatic device;
with the use of a motor; and
by some other method.

4. The clamping device of claim 1 wherein said item is securely held by said clamping device in at least one of the following methods:
said clamp jaws placed on either side of said item;
friction between said item and said clamp jaws;
said clamp jaws resting against appropriate component of said item such that said clamp jaws do not move;
said clamp jaws attached to said item using a hook and loop attachment;
said clamp jaws attached to said item using some other attachment; and
some other method of securely holding said item in said clamping device.

5. A clamping device to assist in the tying of laces on an item, said item being any item using laces, comprising:
two clamp jaws, each said clamp jaw consisting of at least one component;
at least one tightening mechanism attached to each clamp jaw, said at least one tightening mechanism consisting of at least one component;
wherein said clamping device may be placed over said item, such that said two clamp jaws are positioned on each side of said item;
wherein said at least one tightening mechanism can be tightened such that said item is securely held by said clamping device to desired tightness;
wherein said laces can be tied on said item;
wherein said at least one tightening mechanism can be un-tightened such that said clamping device can be removed from said item; and
wherein said tied laces maintain said desired tightness of said item.

6. A clamping device to assist in the tightening of a securing apparatus on an item, said item being any item with at least one securing apparatus, comprising:
two clamp jaws, each said clamp jaw consisting of at least one component;
one tightening mechanism attached to each clamp jaw, said tightening mechanism consisting of at least one component;
wherein said clamping device may be placed over said item, such that said two clamp jaws are positioned on each side of said item;
wherein said tightening mechanism can be tightened such that said item is securely held by said clamping device to desired tightness;
wherein said securing apparatus can be secured on said item, where said securing on said item may also include tightening;
wherein said tightening mechanism can be un-tightened such that said clamping device can be removed from said item; and
wherein said secured securing apparatus maintains said desired tightness of said item.

7. The clamping device of claim 6 wherein said securing apparatus on said item can be at least one of the following:
laces;
hooks and loops;
levers;
bindings;
buckles;
straps; and
some other method of tightening.
